(19) United States
(12) Patent Application Publication
(10) Pub. No.: US 2010/0111546 A1
(43) Pub. Date: May 6, 2010

(54) IMAGE FORMING APPARATUS

(75) Inventor: Tomoaki KUBO, Shizuoka (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/611,498

(22) Filed: Nov. 3, 2009

Related U.S. Application Data
(60) Provisional application No. 61/112,109, filed on Nov. 6, 2008.

(51) Int. Cl. G03G 15/00

(52) U.S. Cl. 399/16

(57) ABSTRACT

A sheet size to be set for a sheet feed section, which feeds a sheet, is stored in a memory. If there is a possibility that a sheet is set in the sheet feed section, image formation is not performed on the first sheet fed from the sheet feed section, but the sheet is conveyed and the length thereof in a conveyance direction is detected. If the detected length of the sheet coincides with the sheet size stored in the memory, the sheet is again conveyed to the image formation section and an image is formed. If the detected length of the sheet does not coincide with the sheet size stored in the memory, the sheet is discharged.

### CROSS-REFERENCE TO RELATED APPLICATION

This application claims the benefit of U.S. Provisional Application No. 61/112,109, filed Nov. 6, 2008.

### TECHNICAL FIELD

The present invention relates to an image forming apparatus, such as a printer or a digital multi-function peripheral, in which a sheet is fed from a containing section selected according to a set value of sheet size and an image is formed on the fed sheet.

### BACKGROUND

Hitherto, an image forming apparatus, such as a printer or a digital multi-function peripheral, often has plural containing sections for containing sheets on which images are formed. The respective containing sections can contain sheets with sizes different from each other. In the image forming apparatus, in order to select a suitable size sheet, the sizes of sheets to be contained in the respective containing sections are set. However, there is a possibility that a user erroneously sets a sheet with a size different from the size set in the containing section. In the related art image forming apparatus, when a sheet with a size different from the set sheet size is set in the containing section, since there is a possibility that conveyance control is performed based on the set sheet size, a possibility of occurrence of a disadvantage such as a jam becomes high. For example, when the set sheet size is different from the size of the sheet actually set in the containing section, in the related art image forming apparatus, the rotation of a conveyance roller is stopped before the sheet is completely carried out, or a preceding sheet and a subsequent sheet collide with each other, and a jam can occur. As techniques to resolve the disadvantage due to the mismatch between the set sheet size and the actually set sheet size, the following techniques are disclosed.

JP-A-2001-348129 or JP-A-2003-246475 discloses a technique in which the length of a fed sheet in a conveyance direction is measured and the presence or absence of a size error is determined based on the measured result.

JP-A-2008-65309 discloses a technique in which a sheet is pulled into a reverse path without performing image formation, and the length of the sheet in the conveyance direction is measured, and further, the sheet pulled into the reverse path is again fed, and printing on the sheet is made possible.

However, in the related art, each time the printing process (print job) is performed, at least one sheet must be conveyed for the measurement of the length.

For example, in the image forming apparatus disclosed in JP-A-2001-348129 or JP-A-2003-246475, the length of the sheet under conveyance is measured while an image is being printed on the first sheet. In JP-A-2001-348129 or JP-A-2003-246475, when the set size and the actual sheet size are different from each other, it is conceivable that the first image is formed on the sheet (first sheet) with a size not intended by the user.

Besides, in the image forming apparatus disclosed in JP-A-2008-65309, each time the printing process (print job) occurs, the first sheet is made to pass through the reverse path, and therefore, it is conceivable that the performance is reduced.

### SUMMARY

According to an aspect of the invention, an image forming apparatus includes a sheet feed section which feeds a sheet on which an image is formed, an image formation section which forms the image on the sheet fed from the sheet feed section, a first conveyance section which conveys the sheet from the sheet feed section to a discharge port through the image formation section, a second conveyance section which branches from a sheet conveyance path of the first conveyance section at a downstream side of the image formation section and again conveys the sheet to the image formation section, a storage section which stores a sheet size to be set for the sheet feed section, a measurement section which measures, if there is a possibility that a new sheet is set in the sheet feed section, a length of a sheet in a conveyance direction, which is conveyed by the first conveyance section, without performing image formation by the image formation section to the first sheet fed from the sheet feed section, and a control section which again conveys the sheet by the second conveyance section to the image formation section to form an image if the length of the sheet measured by the measurement section coincides with the sheet size stored in the storage section, and discharges the sheet if the length of the sheet measured by the measurement section does not coincide with the sheet size stored in the storage section.

Besides, according to another aspect of the invention, a control method used for an image forming apparatus includes storing a sheet size to be set for a sheet feed section to feed a sheet on which an image is formed in a memory, detecting a possibility that a new sheet is set in the sheet feed section, feeding a first sheet from the sheet feed section if it is detected that there is a possibility that the new sheet is set in the sheet feed section, conveying the first sheet fed from the sheet feed section through a first path including an image formation position, measuring a length of the first sheet in a conveyance direction, which is conveyed through the first path, without performing image formation on the sheet, again conveying the sheet through a second path branching from the first path to the image formation position to form an image if the measured length of the sheet coincides with the sheet size stored in the memory, and discharging the sheet if the measured length of the sheet does not coincide with the sheet size stored in the memory.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a sectional view showing a structural example of a printer 1 as an image forming apparatus.

FIG. 2 is a block diagram showing a structure of a control system of a digital multi-function peripheral including a printer.

FIG. 3 is a flowchart for explaining a confirmation process of sheet width.

FIG. 4 is a flowchart for explaining a confirmation process of sheet length.

### DETAILED DESCRIPTION

Hereinafter, embodiments will be described in detail with reference to the drawings.

First, a structure of a printer 1 as an image forming apparatus will be described.

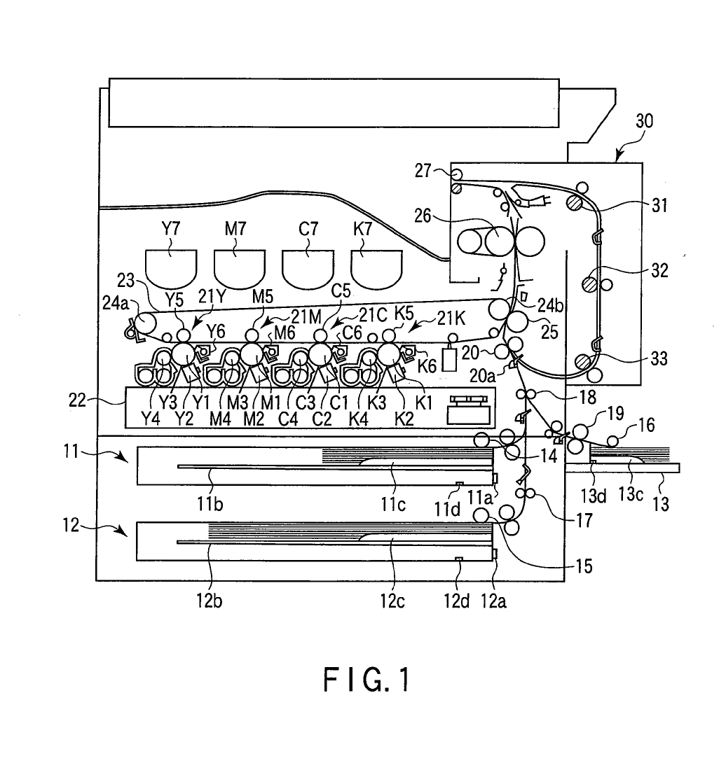

FIG. 1 is a sectional view showing a structure example of the printer 1 as the image forming apparatus. It is supposed that the printer 1 shown in FIG. 1 is applied to a digital multi-function peripheral including a scanner, an external interface and the like.

The printer 1 includes an upper cassette 11, a lower cassette 12 and a manual feed tray 13, which are a sheet feed section to feed a sheet on which an image is printed. The upper cassette 11 and the lower cassette 12 include cassettes as containing sections to contain sheets. The user sets sheets in the upper cassette 11 and the lower cassette 12. The user is required to set the sheets with sizes specified for the upper cassette 11 and lower cassette 12 into the containing section. However, as a physical structure, a sheet with a size other than the specified sheet size can also be set in the upper cassette 11 and the lower cassette 12.

The upper cassette 11 includes an open and close detector 11a, a tray 11b, a conveyance guide 11c and a sheet detection sensor 11d. The lower cassette 12 includes an open and close detector 12a, a tray 12b, a conveyance guide 12c and a sheet detection sensor 12d.

Each of the upper cassette 11 and the lower cassette 12 includes a mechanism (open and close mechanism) by which the sheet containing section can be pulled out so that the user sets a sheet. For example, when the sheet is set in the upper cassette 11, the user pulls out the upper cassette 11. After setting the sheet in the pulled-out upper cassette 11, the user returns the upper cassette 11 to the original position. In a similar procedure, the user can also set sheets in the lower cassette 12.

The open and close detector 11a detects that the upper cassette 11 is pulled out. The open and close detector 12a detects that the lower cassette 12 is pulled out. In an after-mentioned control system, it is determined by the detection result of the detector 11a or 12a that the once pulled-out upper cassette 11 or lower cassette 12 is again set.

The user sets sheets in the state where the upper cassette 11 or the lower cassette 12 is pulled out. Thus, when the open and close detector 11a or 12a detects that the upper cassette 11 or the lower cassette 12 is pulled out (opened), it is possible to determine that there is a possibility that a sheet is newly set in the pulled-out upper cassette 11 or lower cassette 12.

Besides, in a state where the power source of the printer 1 is off, the open and close detector 11a or 12a does not function. Thus, in the state where the power source of the printer 1 is turned off, the opening is not detected by the open and close detector 11a or 12a, and there is a possibility that a new sheet is set in the upper cassette 11 or the lower cassette 12. That is, it is possible to determine that immediately after the power source of the printer 1 is turned on, there is a possibility that a sheet is newly set in the upper cassette 11 or the lower cassette 12.

The trays 11b and 12b respectively have functions to push up sheets contained in the upper cassette 11 and the lower cassette 12. The sheets pushed up by the trays 11b and 12b are pressed against an upper sheet feed roller 14 and a lower sheet feed roller 15.

The conveyance guides 11c and 12c guide a sheet in a sheet width direction (direction orthogonal to a sheet conveyance direction). Each of the conveyance guides 11c and 12c includes a movement mechanism to be moved according to the set sheet size. The user adjusts the conveyance guides 11c and 12c according to the width of the set sheet.

Each of the conveyance guides 11c and 12c has a function to output information indicating the present position (corresponding to the set sheet width). Since the conveyance guides 11c and 12c are adjusted according to the sheet width, it may be determined that the present positions of the conveyance guides 11c and 12c indicate the sheet widths set for the conveyance guides 11c and 12c. That is, the conveyance guides 11c and 12c function also as width detectors to detect the set sheet width.

The sheet detection sensors 11d and 12d are sensors to detect the presence or absence of a sheet. The sheet detection sensors 11d and 12d outputs signals indicating whether or not a sheet exists in the upper cassette 11 or the lower cassette 12.

The manual feed tray 13 is a tray on which the user can place a sheet in an untouched state (that is, without pull out). The user is required to place a sheet with a set size on the manual feed tray 13. However, as a physical structure, a sheet with a size other that the set sheet size can also be set on the manual feed tray 13.

The manual feed tray 13 includes a conveyance guide 13c and a sheet detection sensor 13d. The manual feed tray 13 includes a mechanism to push up the placed sheet. The sheet set on the manual feed tray 13 is pushed up and contacts with a manual sheet feed roller 16.

The conveyance guide 13c guides the sheet, which is set on the manual feed tray 13, in the width direction (direction orthogonal to the sheet conveyance direction). The conveyance guide 13c includes a movement mechanism moved according to the set sheet size. The user adjusts the conveyance guide 13c according to the width of the set sheet. The conveyance guide 13c has a function to output information indicating the present position (corresponding to the set sheet width). Since the conveyance guide 13c is adjusted according to the sheet width, it may be determined that the present position of the conveyance guide 13c indicates the width of the sheet set on the manual feed tray 13. That is, the conveyance guide 13c functions also as a width detector to detect the width of the sheet set on the manual feed tray 13.

The sheet detection sensor 13d detects the presence or absence of a sheet on the manual feed tray 13. The sheet detection sensor 13d outputs a signal indicating whether or not a sheet exists on the manual feed tray 13.

The upper sheet feed roller 14 takes out sheets contained in the upper cassette 11 one by one. The lower sheet feed roller 15 takes out sheets contained in the lower cassette 12 one by one. The manual feed roller 16 takes out sheets placed on the manual feed tray 13 one by one. A lower conveyance roller 17 conveys the sheet taken out by the lower sheet feed roller 15 to an upper conveyance roller 18. A manual conveyance roller 19 conveys the sheet taken out by the manual feed roller 16 to the upper conveyance roller 18. The upper conveyance roller 18 conveys the sheet taken out by the upper sheet feed roller 14, the sheet conveyed by the lower conveyance roller 17, or the sheet conveyed by the manual conveyance roller 19 to a register roller 20.

The register roller 20 conveys the sheet at a desired timing (timing when an image is transferred to the sheet). The sheet conveyed by the upper conveyance roller 18 is once stopped at the time point when the leading edge of the sheet reaches the register roller 20. The register roller 20 starts, at a desired timing, to convey the sheet whose conveyance is once stopped. The register roller 20 rotates to convey the sheet at a constant conveyance speed. That is, the conveyance speed of the sheet by the register roller 20 is the constant conveyance speed.

A register sensor 20a is installed just before the register roller 20. The register sensor 20a detects the sheet reaching the register roller 20 and the sheet conveyed by the register roller 20. For example, the register sensor 20a outputs an on signal in a state where the sheet is detected, and outputs an off signal in a state where the sheet is not detected. When the output signal of the register sensor 20a is changed from off to on, it is determined that the sheet conveyed by the upper conveyance roller 18 reaches the register roller 20. When the output signal of the register sensor 20 is changed from on to off, it is determined that the conveyance of the sheet by the register roller 20 is ended. The after-mentioned control system has a function to determine the length of the sheet by the conveyance speed of the sheet and the time from turning-on of the register sensor 20a to turning-off thereof (that is, the time in which the register roller 20 conveys the sheet).

Plural image formation sections (21K, 21C, 21M, 21Y) are disposed to face an exposure unit 22 and an intermediate transfer belt 23. The exposure unit 22 forms electrostatic latent images as respective color images on image carriers in the respective image formation units (21K, 21C, 21M, 21Y). The intermediate transfer belt 23 is an intermediate transfer body as a transfer target body. A drive roller 24a and a support roller 24b hold the intermediate transfer belt 23 as the transfer target body at a suitable tension. The intermediate transfer belt 23 is driven in accordance with the rotation of the drive roller 24a. The respective image formation sections (21K, 21C, 21M, 21Y) form toner images on the intermediate transfer belt 23 by developing the electrostatic latent images with respective color toners.

The respective image formation sections 21Y (21M, 21C, 21K) respectively include photoconductive drums Y1 (M1, C1, K1), charging rollers Y2 (M2, C2, K2), exposure sections Y3 (M3, C3, K3), developing units Y4 (M4, C4, K4), transfer rollers Y5 (M5, C5, K5), cleaners Y6 (M6, C6, K6) and toner cartridges Y7 (M7, C7, K7). The respective image formation sections 21Y, 21M, 21C and 21K have the same structure. Thus, the image formation section 21Y will be described, and the detailed description of the respective image formation sections 21M, 21C and 21K other than the image formation section 21Y will be omitted.

The photoconductive drum Y1 is the image carrier. The photoconductive drum Y1 includes an organic or amorphous silicon photoconductive layer on a conductive substrate. For example, the photoconductive drum Y1 is an organic photoconductive body charged to a minus polarity. The charging roller Y2 uniformly charges the surface of the photoconductive drum Y1 rotated by a not-shown motor. The exposure unit 22 emits image modulated laser light. The exposure unit 22 irradiates the laser light to the exposure section Y3 of the photoconductive drum Y1 through a polygon mirror and a not-shown optical member. The exposure section Y3 is a surface area of the photoconductive drum Y1 which was charged by the charging roller Y2. An electrostatic latent image is formed on the surface of the photoconductive drum Y1 exposed by the laser light in the exposure section Y3.

The developing unit Y4 develops (visualizes) the electrostatic latent image formed on the surface of the photoconductive drum Y1. The developing unit Y4 develops the electrostatic latent image by a two-component developing system in which a nonmagnetic toner charged to a negative polarity and a magnetic toner are mixed. The toner does not adhere to a part (unexposed part) of the surface of the photoconductive drum Y1 where the laser light is not irradiated, and the toner adheres to a part (exposed part) irradiated with the laser light. The photoconductive drum Y1 holds the toner image appearing by the adhesion of the toner. Incidentally, the developing system is not limited to the two-component developing system, and a system such as contact one-component development, non-contact one-component development, or conductive one-component development can also be applied.

The toner image formed on the surface of the photoconductive drum Y1 is transferred to the intermediate transfer belt 23 as the transfer target body. The transfer roller Y5 as the transfer member contacts with the back of the intermediate transfer belt 23 when viewed from the photoconductive drum Y1 side. The transfer roller Y5 supplies an electric field for transferring the toner image from the back of the intermediate transfer belt 23. The cleaner Y6 removes the remaining toner remaining on the surface of the photoconductive drum Y1 after transfer. The cleaner Y6 is provided on this side of the charging roller Y2 in the rotation direction of the photoconductive drum Y1. Besides, the toner cartridge Y7 contains the toner supplied to the developing unit Y4.

The respective image formation sections 21Y, 21M, 21C and 21K superimpose the toner images developed with the respective color toners on the intermediate transfer belt 23 and transfer them (primary transfer). A color image in which the respective color toner images are superimposed on each other is formed on the intermediate transfer belt 23. The color image of the plural color toners transferred on the intermediate transfer belt 23 is transferred to the sheet at a secondary transfer position. The secondary transfer position is the position where the toner images on the intermediate transfer belt 23 are transferred to the sheet. The secondary transfer position is the position where the support roller 24b and a secondary transfer roller 25 face each other.

The register roller 20 conveys the sheet to a secondary transfer position 25a as the image transfer position in timing with the toner image on the intermediate transfer belt 23. The toner image on the intermediate transfer belt 23 is transferred to the sheet at the secondary transfer position 25a. When the support roller 24b is grounded, a positive (+) polarity bias is applied to the secondary transfer roller 25 in order to transfer the toner to the sheet P as the second transfer target body. Incidentally, a structure may be such that the secondary transfer roller 25 is grounded, and a negative polarity bias is applied to the support roller 24b. The sheet on which the toner image is transferred at the secondary transfer position passes through a fixing unit 26. The fixing unit 26 fixes the toner image transferred on the sheet to the sheet.

The fixing unit 26 conveys the sheet to a paper discharge roller 27. The paper discharge roller 27 discharge the sheet to a discharge section 28. A reverse gate 29 is provided between the fixing unit 26 and the paper discharge roller 27. The reverse gate 29 guides the sheet conveyed from the fixing unit 26 to the paper discharge roller 27. The reverse gate 29 guides the sheet switched back from the paper discharge roller 27 to an auto duplex unit (ADU) 30. The ADU 30 includes plural conveyance rollers 31, 32 and 33. The plural conveyance rollers 31, 32 and 33 convey the sheet switched back from the paper discharge roller 27 to the register roller 20.

Incidentally, the structure example shown in FIG. 1 is the printer to form an image on a sheet by an electrophotographic system. However, the embodiment is not limited to the printer of the electrophotographic system. For example, the embodiment can be applied also to an ink jet system printer or a thermal transfer system printer.

Next, the structure of the control system in the printer 1 will be described.

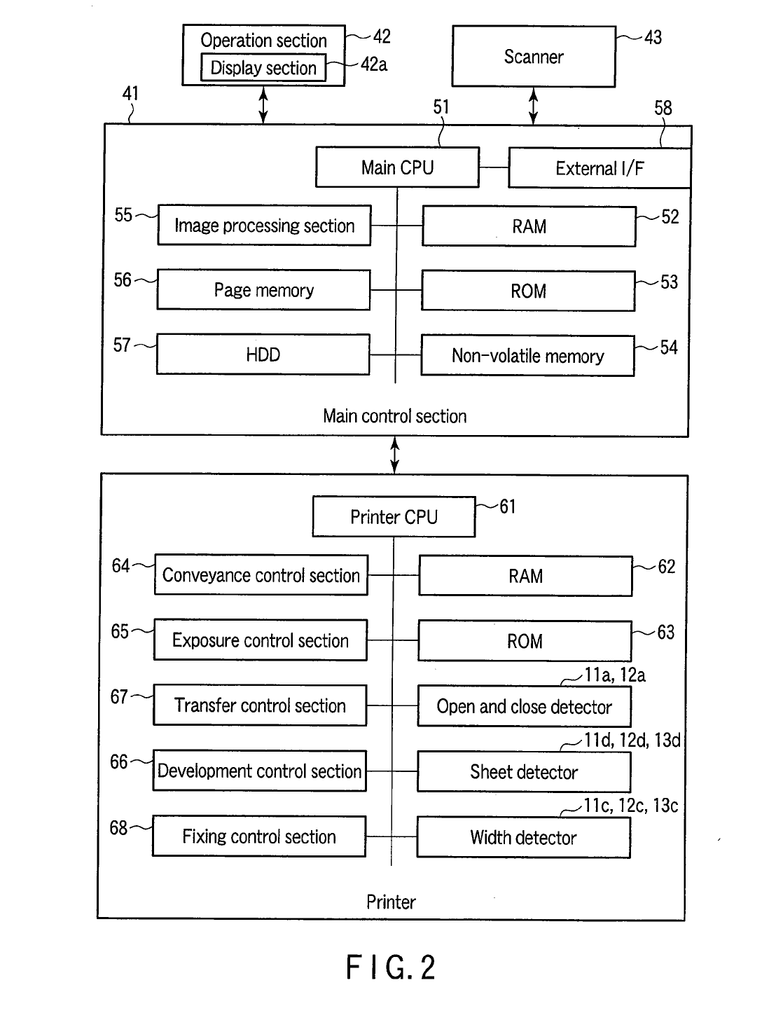

FIG. 2 is a block diagram showing the structure of the control system of the digital multi-function peripheral including the printer 1.

As shown in FIG. 2, the control system of the digital multi-function peripheral includes a main control section 41, an operation section 42, a scanner 43 and the printer 1.

The operation section 42 is a user interface to which an operation instruction from a user is inputted. The operation section 42 includes, for example, a hard key such as a numeric keypad, and a display section 42a having a built-in touch panel. The display section 42a of the operation section 42 displays an operation guide, a touch key (icon) capable of being selected by the touch panel or the like. For example, the operation section 42 detects through the touch panel that the user touches the touch key (icon) displayed on the display section 42a. Besides, the display section 42a of the operation section 42 displays a guide indicating that printing is possible, together with the guide of the operation, and displays a guide of error contents when a print error occurs.

The scanner 43 functions as an image read section to convert an image on a document surface into image data. The scanner 43 converts, for example, the image of the document into color or monochrome digital image data. The scanner 43 includes a scanning section (not shown) to optically scan the document surface, a photoelectric conversion section (not shown), such as a CCD line sensor, to convert the reflected light from the document surface optically scanned by the scanning section into an electric signal, and the like.

The main control section 41 controls the whole digital multi-function peripheral including the printer 1. The main control section 41 includes a main CPU 51, a RAM 52, a ROM 53, a non-volatile memory 54, an image processing section 55, a page memory 56, a HDD 57 and an external I/F 58.

The main CPU 51 performs control of the respective sections in the main control section 41, data processing and the like. The main CPU 51 executes a control program stored in the ROM 53, the non-volatile memory 54 or the HDD 57, and realizes various processes and various functions. For example, the main CPU 51 controls the scanner 43 and the printer 1 by a control program for copying, and realizes copying as one of print jobs. Besides, the main CPU 51 controls the external I/F 58 and the printer 1 by a control program for printing, and realizes network printing as one of the print jobs.

The RAM 52 is a memory for temporarily storing working data or for storing reference data. The ROM 53 is an unrewritable non-volatile memory. The ROM 53 stores, for example, the control program for controlling the digital multi-function peripheral, control data and the like.

The non-volatile memory 54 is a rewritable non-volatile memory. The non-volatile memory 54 includes an EEPROM or a flash ROM. The non-volatile memory 54 stores system setting information. In this embodiment, the non-volatile memory 54 stores set values of sizes of sheets to be set in the upper cassette 11 and the lower cassette 12 and on the manual feed tray 13 which are plural sheet feed sections. Incidentally, the set values of the sizes of the sheets in the upper cassette 11, the lower cassette 12 and the manual tray 13 are values indicating at least the sheet width and the sheet length in the sheet conveyance direction.

The image processing section 55 performs various image processes on image data. The image processing section 55 performs image processes such as correction of image data, compression thereof or expansion thereof. For example, when a copying process is performed, the image processing section 55 performs image processes, such as shading correction, gradation correction, and in-line correction, on the image data read by the scanner 43.

The page memory 56 is a memory having a storage area in which image data of at least one page is expanded. The HDD 57 is a large capacity storage device. The HDD 57 is used also as a backup memory for various data. The HDD 57 may store various set data or management data.

The external I/F 58 is an interface to perform network communication. The external I/F 58 is, for example, an interface for data communication with an external device connected to a local area network (LAN) through network cable or wireless communication. For example, when the printer 1 functions as a network printer, the external I/F 58 receives image data for printing.

The control system of the printer 1 includes a printer CPU 61, a RAM 62, a ROM 63, the ADU 30, a conveyance control section 64, an exposure control section 65, a development control section 66, a transfer control section 67, a fixing control section 68 and the like.

The printer CPU 61 controls the respective sections in the printer 1. The printer CPU 61 realizes various functions by executing a control program stored in the ROM 63 or the like. The printer CPU 61 performs a process of forming an image on a sheet according to an instruction from the main control section 41. Besides, the conveyance control section 64, the exposure control section 65, the development control section 66, the transfer control section 67 and the fixing control section 68 may be made functions realized by execution of the control program by the printer CPU 61.

The printer CPU 61 inputs detection signals of the respective detectors (the open and close detectors 11a and 12a, the sheet detection sensors 11d, 12d and 13d, and the conveyance guides 11c, 12c and 13c which function as the width detectors). The printer CPU 61 notifies the detection signals of the respective detectors to the main control section 41. However, the detection signals of the respective detectors may be directly inputted to the main CPU 51 of the main control section 41.

The RAM 62 is a memory for temporarily storing working data or for storing reference data. The ROM 63 is an unrewritable non-volatile memory. The ROM 63 stores, for example, a control program for controlling the printer 1, control data and the like.

The conveyance control section 64 controls the conveyance of sheets taken out from the respective sheet feed cassettes 11 and 12 and the manual feed tray 13. The conveyance control section 64 controls the operations of the sheet feed rollers 14, 15 and 16, the conveyance rollers 17, 18 and 19, the register roller 20 and the like based on the operation instructions of the printer CPU 61. For example, the conveyance control section 64 drive controls the respective conveyance rollers in the ADU 30, and performs conveyance control to again supply the sheet, which was once conveyed to the paper discharge roller 27, to the register roller 20.

The exposure control section 65 controls the operation of the exposure unit 22. The exposure control section 65 controls the exposure unit 22, so that laser light is irradiated to the surfaces of the respective photoconductive drums Y1, M1, C1 and K1 as the image carriers and electrostatic latent images are formed. The development control section 66 controls so that the respective developing units Y4, M4, C4 and K4 supply toners to the respective photoconductive drums Y1, M1, C1 and K1. The transfer control section 67 performs control to transfer the toner images formed on the respective photoconductive drums Y1, M1, C1 and K1 onto the transfer belt 23, and control to transfer the toner images formed on the transfer belt 23 to the sheet. The fixing control section 68 controls the fixing process of the toner images to the sheet.

Next, the operation of the printer 1 will be described.

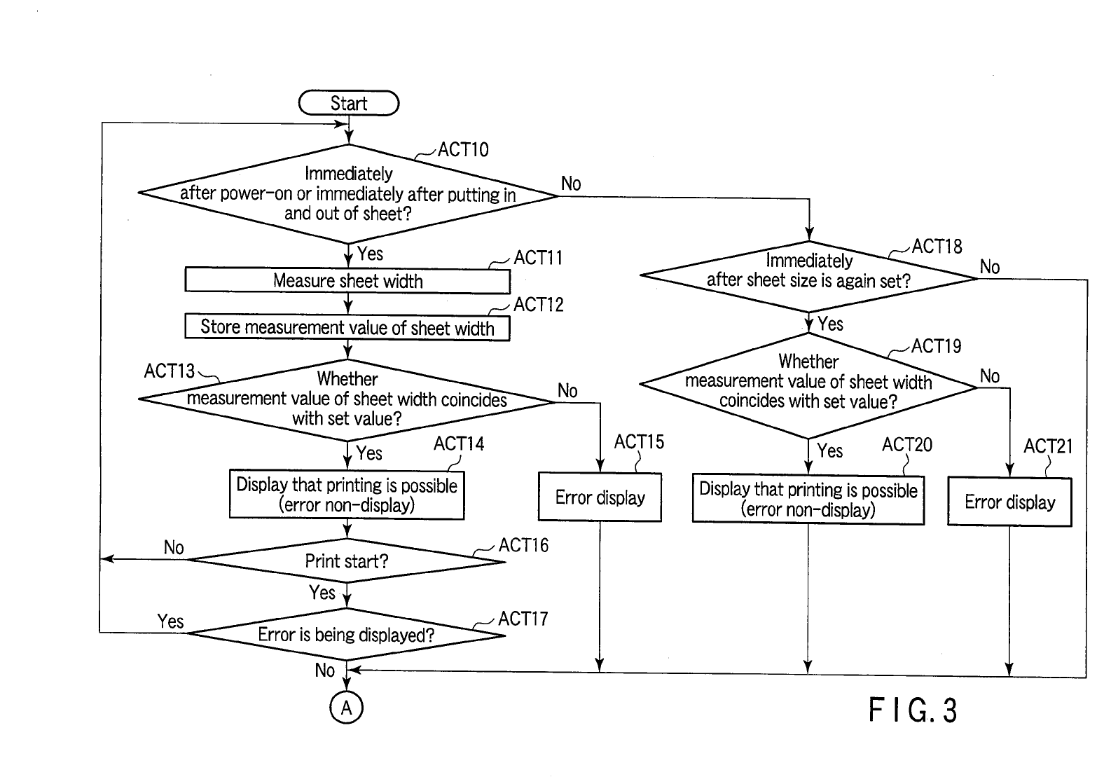

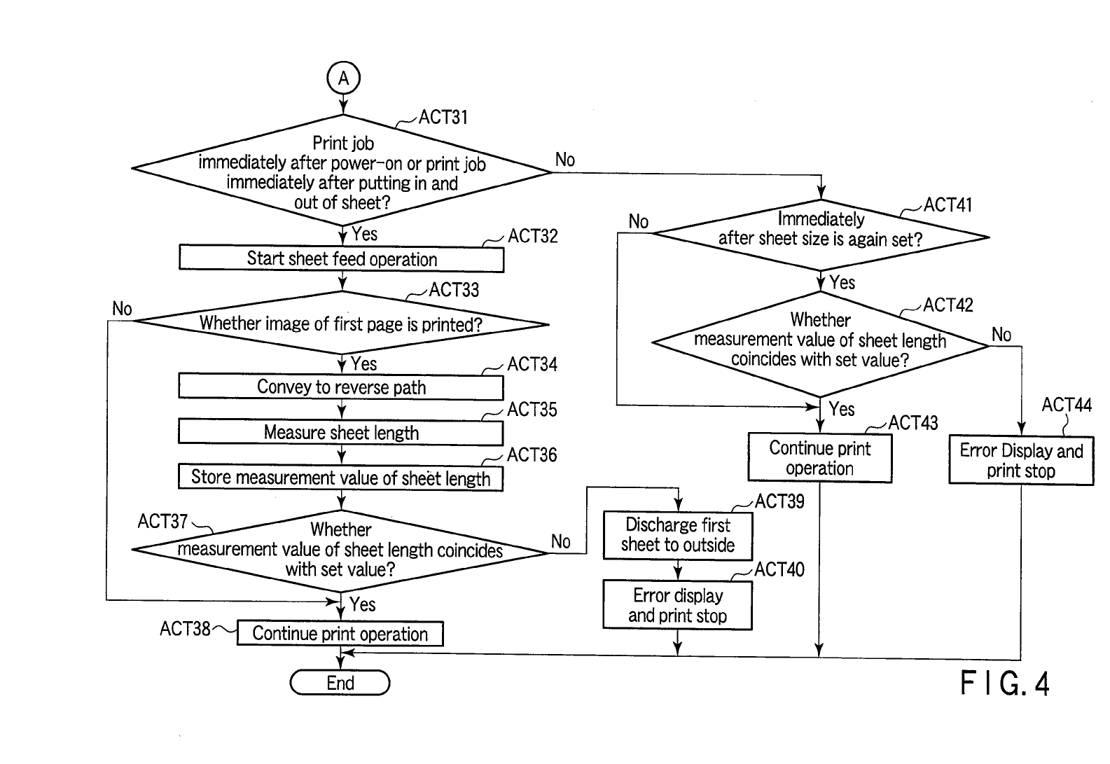

FIG. 3 and FIG. 4 are flowcharts for explaining a confirmation process of a size of a sheet set in the upper cassette 11 or the lower cassette 12 or on the manual feed tray 13.

First, the process of confirming the sheet width (length of the sheet in a direction orthogonal to the conveyance direction) will be described.

FIG. 3 is a flowchart for explaining the process to confirm the sheet width (length of the sheet in the direction orthogonal to the conveyance direction).

Immediately after the power source of the printer 1 is turned on (ACT 10, YES), the main CPU 51 detects the widths of the sheets set in the upper cassette 11, the lower cassette 12 and the manual feed tray 13 (ACT 11). Besides, also immediately after a sheet is put in and out (ACT 10, YES), the main CPU 51 detects the width of the sheet set in the cassette 11, 12 or the tray 13 in which the sheet is put in and out (ACT 11). The main CPU 51 stores information indicating the detected sheet width in the memory such as the RAM 52 or the non-volatile memory 54 (ACT 12).

Here, as shown in FIG. 1, the upper cassette 11, the lower cassette 12, and the manual feed tray 13 include the conveyance guides 11c, 12c and 13c adjusted according to the sheet width. The respective conveyance guides 11c, 12c and 13c output information indicating the present position (corresponding to the sheet width). The main CPU 51 detects the width of the sheet set in the upper cassette 11 or the lower cassette 12 or on the manual feed tray 13 based on the information indicating the position (corresponding to the sheet width) from the respective conveyance guides 11c, 12c and 13c.

When the width of the sheet set in the upper cassette 11 or the lower cassette 12 or on the manual feed tray 13 is detected, the main CPU 51 determines whether or not the detected sheet width coincides with the set value for each of the upper cassette 11, the lower cassette 12 and the manual feed tray 13 (ACT 13).

When it is determined in the above determination that the detected sheet width and the set value coincide with each other (ACT 13, YES), the main CPU 51 causes the display section 42a of the operation section 42 to display that printing is possible (ACT 14). In the state where the display section 42a displays that printing is possible, the main CPU 51 becomes in the state where the printing process can be executed. That is, when a request for print starting is received (ACT 16, YES), and when the state is such that the display section 42a displays that printing is possible (ACT 17, NO), the main CPU 51 starts to print. When printing is started, the main CPU 51 gives a print job indicating print contents to the printer CPU 61.

When it is determined that the detected sheet width does not coincide with the set value (ACT 13, NO), the main CPU 51 causes the display section 42a of the operation section 42 to display an error guide indicating that the sheet size is different from the set value (ACT 15). In the state where the display section 42a displays the error guide, the main CPU 51 makes print starting impossible. That is, when a request for print starting is received (ACT 16, YES), and when the state is such that the display section 42a displays the error guide (ACT 17, YES), the main CPU 51 makes print execution impossible.

When the display section 42a displays the error guide (that is, when printing becomes impossible due to the inconsistency in size), the user again sets a sheet with a width matching with the set value or changes the set value of the sheet size.

For example, when the user again sets a sheet, the main CPU 51 detects the putting in and out of the sheet by the cassette detector 11a, 12a or the sheet detector 11d, 12d, 13d, and again executes the process from ACT 10.

When the user changes (sets again) the set value of the sheet size (ACT 18, YES), the main CPU 51 determines whether or not the detected sheet width coincides with the sheet size set again (again set value) (ACT 19).

When it is determined in the above determination that the detected sheet width coincides with the again set value (ACT 19, YES), the main CPU 51 causes the display section 42a of the operation section 42 to display that printing is possible, instead of the error guide (ACT 20). When the display section 42a displays that printing is possible, the main CPU 51 becomes in the state where the print process can be executed. When it is determined that the detected sheet width does not coincide with the again set value (ACT 19, NO), the main CPU 51 causes the display section 42a to display the error guide, which is being displayed, as it is (ACT 21). When the display section 42a displays the error guide, the main CPU 51 makes print starting impossible.

According to the process, in the printer, immediately after the power source is turned on or immediately after the putting in and out of the sheet is performed, the width of the actually set sheet is detected, and it is checked whether the detected sheet width coincides with the set value. As a result of this, when it is determined that the sheet with the width different from the set value is set at power-on or immediately after the sheet is set, printing is made impossible, and inconsistency in sheet width can be notified to the user.

Besides, in the printer, the result of detection of the width of the actually set sheet is stored in the memory, and in neither the case of immediately after power-on nor the case of immediately after putting in and out of the sheet, but immediately after the sheet size is again set, it is checked whether the detected sheet width stored in the memory coincides with the again set value. As a result of this, when the setting of the sheet size is changed, even if the sheet width is not detected, it can be determined whether the width of the actually set sheet coincides with the set value.

Next, the process of confirming the length of a sheet in the conveyance direction will be described.

FIG. 4 is a flowchart for explaining the process of confirming the length of the sheet (length of the sheet in the conveyance direction).

When print starting is possible, the main CPU 51 gives a print job indicating print contents to the printer CPU 61. In the print job, for example, a cassette or a tray as a sheet feed source is specified. When the print job is given, the printer CPU 61 determines whether or not the state is immediately after the power source of the printer 1 is turned on or immediately after putting in and out of the sheet is performed in the cassette or tray specified by the print job (ACT 31). When it is determined that the state is immediately after the power source is turned on or immediately after the putting in and out of the sheet is performed (ACT 31, YES), the printer CPU 61 starts an operation of feeding the first sheet from the specified cassette 11, 12 or the manual feed tray 13 (ACT 32).

When the first sheet is fed (ACT 33, YES), the printer CPU 61 guides the sheet to the ADU 30 (ACT 34), and measures the length of the sheet in the conveyance direction (ACT 35). The length of the sheet in the conveyance direction is calculated based on a period of time from a time when the register roller 20 starts to convey the sheet to a time when the register sensor 20a stops detecting the sheet, and the conveyance speed. The printer CPU 61 stores information indicating the measured length of the sheet into the memory such as the RAM 62, the RAM 52 or the non-volatile memory 54 (ACT 36).

When the length of the sheet is measured, the printer CPU 61 determines whether or not the sheet length obtained as the measurement result coincides with the set value of the sheet size for the cassette 11, 12 or the manual feed tray 13 from which the sheet is fed (ACT 37).

When it is determined in the above determination that the measured sheet length coincides with the set value (ACT 37, YES), the printer CPU 61 prints an image of a first page to the first sheet conveyed to the register roller 20 again by the ADU 30 (ACT 38). When printing of the image of the first page is successful, the printer CPU 61 continuously performs, as the print process of the second and subsequent pages, the process of sequentially printing images of the second and subsequent pages without measuring the sheet length (ACT 38).

When it is determined that the measured sheet length does not coincide with the set value (ACT 37, NO), the printer CPU 61 does not print on the sheet conveyed to the register roller 20 again by the ADU 30, and discharges the sheet to the outside (ACT 39). Incidentally, in the printer in which the sheet length can be measured without guiding the sheet to the ADU 30, when it is determined that the measured sheet length does not coincide with the set value, the printer CPU 61 may discharge the sheet without causing it to pass through the ADU 30.

When the sheet is discharged without printing of an image, the printer CPU 61 notifies the main CPU 51 that a print error occurs because the measured sheet length does not coincide with the set value. The main CPU 51 receiving the notification of the print error cause the display section 42a of the operation section 42 to display the error guide indicating that the measured sheet length is different from the set value (ACT 40). When the display section 42a displays the error guide, the main CPU 51 makes printing impossible.

When the error guide indicating that the measured sheet length is different from the set value is displayed (that is, when printing becomes impossible due to inconsistency in size), the user again sets a sheet with a size coincident with the set value for the cassette 11, 12 or the manual feed tray 13 in which the error occurs, or changes the set value of the sheet size for the cassette 11, 12 or the manual feed tray 13 in which the error occurs.

For example, when the user again sets the sheet, the main CPU 51 detects the putting in and out of the sheet by the cassette detector 11a, 12a or the sheet detector 11d, 12d, 13d. When the putting in and out of the sheet is detected, the printer CPU 61 again executes the process from ACT 32 in the immediate print job.

Besides, when the user changes (again sets) the set value of the sheet size (ACT 41, YES), in the print job immediately after the setting is again performed, the printer CPU 61 determines whether or not the measured value of the sheet length stored in the memory such as the RAM 62 coincides with the again set sheet size (again set value) (ACT 42). Incidentally, immediately after only the setting of the sheet size is again performed, the printer 1 is in neither the state of immediately after power-on nor the state of immediately after putting in and out of the sheet. Thus, it is conceivable that even if the operation of actually measuring the sheet length is not performed, the printer CPU 61 has only to determine whether the measurement value of the sheet length stored in the memory coincides with the again set value.

When it is determined in the above determination that the measurement value of the sheet length stored in the memory coincides with the again set value (ACT 42, YES), the printer CPU 61 causes the display section 42a of the operation section 42 to display that printing is possible, instead of the error guide, and executes the print process corresponding to the print job (ACT 43).

When it is determined that the measured sheet length does not coincide with the again set value (ACT 42, NO), the printer CPU 61 notifies the main CPU 51 of the print error due to inconsistency between the sheet length and the set value. The main CPU 51 receiving the notification of the print error causes the display section 42a of the operation section 42 to display the error guide indicating that the measured sheet length is different from the again set value (ACT 44). When the display section 42a displays the error guide, the main CPU 51 makes printing impossible.

According to the above process, in the printer 1, immediately after the power source is turned on, or immediately after the putting in and out of the sheet is performed, the fed sheet is once conveyed to the ADU to actually measure the length of the sheet, and it is checked whether the measured sheet length coincides with the set value. As a result of this, when the sheet with the length different from the set value is set at power-on or immediately after the sheet is set, printing is stopped, and the inconsistency in sheet size can be informed to the user.

Besides, in the printer, the result of measurement of the length of the actually set sheet is stored in the memory, and in neither the state of immediately after power-on nor the state of immediately after putting in and out of the sheet, immediately after the sheet size is again set, it is checked whether the measured sheet length stored in the memory coincides with the again set value. As a result of this, when the setting of the sheet size is changed, even if the measurement operation of the sheet length is not performed, it can be determined whether the length of the actually set sheet coincides with the set value.

Incidentally, the process of ACT 10 to ACT 17 shown in FIG. 3 is premised on the structure in which the sensor to detect the width of the sheet is provided in the sheet feed section (the upper cassette 11, the lower cassette 12 or the manual feed tray 13) of the printer 1. However, the printer 1 can have a structure in which the sensor to detect the width of the sheet is not provided in the upper cassette 11, the lower cassette 12 or the manual tray 13. In the printer having the structure as stated above, the process shown in FIG. 3 is omitted, and the process shown in FIG. 4 described later may be performed. Even when the process of FIG. 3 is omitted, since the length in the conveyance direction can be confirmed, the effect of preventing the occurrence of a jam or the like in conveyance can be obtained.

Besides, although the manual feed tray provided in the printer often has the conveyance guide capable of detecting the sheet width, it seldom has a sensor to detect the sheet length. That is, in many manual feed trays used for printers, only the sheet width can be detected. In view of such circumstances, it is conceivable that the process as shown in FIG. 4 is suitable for the process of checking the size of the sheet set on the manual feed tray.

Besides, the manual feed tray has the structure in which the user can easily set sheets. Thus, a sheet with a size different from the set sheet size is liable to be erroneously set on the manual feed tray. Further, in the manual feed tray having the conveyance guide, it is conceivable that although an error in the sheet width hardly occurs by virtue of the conveyance guide, an error in the sheet length is liable to occur. Accordingly, it is conceivable that when the process shown in FIG. 4 is applied to the sheet fed from the manual feed tray, many disadvantages due to inconsistency between the set sheet size and the actual sheet size can be prevented.

Additional advantages and modifications will readily occur to those skilled in the art. Therefore, the invention in its broader aspects is not limited to the specific details and representative embodiment shown and described herein. Accordingly, various modifications may be made without departing from the spirit or scope of the general inventive concept as defined by the appended claims and their equivalents.

What is claimed is:

1. An image forming apparatus comprising:
a sheet feed section which feeds a sheet on which an image is formed;
an image formation section which forms the image on the sheet fed from the sheet feed section;
a first conveyance section which conveys the sheet from the sheet feed section to a discharge port through the image formation section;
a second conveyance section which branches from a sheet conveyance path of the first conveyance section at a downstream side of the image formation section and again conveys the sheet to the image formation section;
a storage section which stores a sheet size to be set for the sheet feed section;
a measurement section which measures, if there is a possibility that a new sheet is set in the sheet feed section, a length of a sheet in a conveyance direction, which is conveyed by the first conveyance section, without performing image formation by the image formation section to the first sheet fed from the sheet feed section; and
a control section which again conveys the sheet by the second conveyance section to the image formation section to form an image if the length of the sheet measured by the measurement section coincides with the sheet size stored in the storage section, and discharges the sheet if the length of the sheet measured by the measurement section does not coincide with the sheet size stored in the storage section.

2. The apparatus of claim 1, wherein the sheet feed section is a manual feed tray.

3. The apparatus of claim 1, wherein the sheet feed section is a cassette.

4. The apparatus of claim 1, further comprising an open and close detector which detects that a containing section of the sheet fed by the sheet feed section is opened,
wherein after the open and close detector detects that the containing section is opened, the measurement section detects the length of the sheet in the conveyance direction, which is conveyed by the first conveyance section, without performing the image formation by the image formation section to the first sheet fed from the sheet feed section.

5. The apparatus of claim 1, wherein
after a power source of the apparatus is turned on, the measurement section detects the length of the sheet in the conveyance direction, which is conveyed by the first conveyance section, without performing the image formation by the image formation section to the first sheet fed from the sheet feed section.

6. The apparatus of claim 1, further comprising a display section which displays that a size of the sheet set in the sheet feed section is different from a set value of the sheet size for the sheet feed section if the length of the sheet measured by the measurement section does not coincide with the sheet size stored in the storage section.

7. The apparatus of claim 1, wherein if the length of the sheet measured by the measurement section does not coincide with the sheet size stored in the storage section, the sheet conveyed to the image formation section again by the second conveyance section is discharged without being subjected to the image formation.

8. The apparatus of claim 1, wherein if the length of the sheet measured by the measurement section does not coincide with the sheet size stored in the storage section, the sheet is discharged without passing through the second conveyance section.

9. The apparatus of claim 1, further comprising:
a memory which stores information indicating the length of the sheet measured by the measurement section;
a determination section which determines, if a set value of the sheet size to be set for the sheet feed section is changed, whether the length of the sheet measured by the measurement section and stored in the memory coincides with the changed set value of the sheet size; and
a display section which displays, if the determination section determines that the length of the sheet measured by the measurement section and stored in the memory does not coincide with the changed set value of the sheet size, that a size of the sheet set in the sheet feed section is different from the set value of the sheet size for the sheet feed section.

10. The apparatus of claim 1, further comprising:
a width detection section which detects a width of a sheet set in the sheet feed section; and
a display section which displays, if the width of the sheet detected by the width detection section does not coincide with the sheet size stored in the storage section, that a size of the sheet set in the sheet feed section is different from a set value of the sheet size for the sheet feed section.

11. The apparatus of claim 10, wherein the width detection section includes a conveyance guide which is adjusted according to the width of the sheet set in the sheet feed section.

12. The apparatus of claim 11, wherein
the sheet feed section is a manual feed tray, and
the conveyance guide supports a sheet, in a width direction, placed on the manual feed tray.

13. The apparatus of claim 10, further comprising an open and close detector which detects that a containing section of the sheet fed by the sheet feed section is opened,
wherein after the open and close detector detects that the containing section is opened, before a first sheet is fed from the sheet feed section, the width detection section detects the width of the sheet set in the sheet feed section.

14. The apparatus of claim 13, wherein
after the open and close detector detects that the containing section is opened, the measurement section measures the length of the sheet, in the conveyance direction, conveyed by the first conveyance section without performing the image formation by the image formation section to the first sheet fed from the sheet feed section, and
the display section displays that the size of the sheet set in the sheet feed section is different from the set value of the sheet size for the sheet feed section if the width of the sheet detected by the width detection section does not coincide with the sheet size stored in the storage section or if the length of the sheet measured by the measurement section does not coincide with the sheet size stored in the storage section.

15. The apparatus of claim 10, wherein
the width detection section detects the width of the sheet set in the sheet feed section after a power source of the apparatus is turned on and before a first sheet is fed from the sheet feed section.

16. The apparatus of claim 15, wherein
after the power source of the apparatus is turned on, the measurement section measures the length of the sheet, in the conveyance direction, conveyed by the first conveyance section without performing the image formation by the image formation section to the first sheet fed from the sheet feed section, and
the display section displays that the size of the sheet set in the sheet feed section is different from the set value of the sheet size for the sheet feed section if the width of the sheet detected by the width detection section does not coincide with the sheet size stored in the storage section or if the length of the sheet measured by the measurement section does not coincide with the sheet size stored in the storage section.

17. The apparatus of claim 10, further comprising:
a memory which stores information indicating the sheet width detected by the width detection section;
a determination section which determines, if the set value of the sheet size to be set for the sheet feed section is changed, whether the sheet width detected by the width detection section and stored in the memory coincides with the changed set value of the sheet size; and
a display section displays that the size of the sheet set in the sheet feed section is different from the set value of the sheet size for the sheet feed section if the determination section determines that the sheet width detected by the width detection section and stored in the memory does not coincide with the changed set value of the sheet size.

18. A control method used for an image forming apparatus, comprising:
storing a sheet size to be set for a sheet feed section to feed a sheet on which an image is formed in a memory;
detecting a possibility that a new sheet is set in the sheet feed section;
feeding a first sheet from the sheet feed section if it is detected that there is a possibility that the new sheet is set in the sheet feed section;
conveying the first sheet fed from the sheet feed section through a first path including an image formation position;
measuring a length of the first sheet in a conveyance direction, which is conveyed through the first path, without performing image formation on the sheet;
again conveying the sheet through a second path branching from the first path to the image formation position to form an image if the measured length of the sheet coincides with the sheet size stored in the memory; and
discharging the sheet if the measured length of the sheet does not coincide with the sheet size stored in the memory.

19. The method of claim 18, wherein
it is detected that a containing section of the sheet fed by the sheet feed section is opened, and
in the measuring of the length, after it is detected that the containing section is opened, the length, in a conveyance direction, of the first sheet fed from the sheet feed section is measured.

20. The method of claim 18, wherein
in the measuring of the length, after a power source of the apparatus is turned on, the length, in a conveyance direction, of the first sheet fed from the sheet feed section is measured.
